(19) United States
(12) Patent Application Publication
(10) Pub. No.: US 2012/0057022 A1
(43) Pub. Date: Mar. 8, 2012

(54) APPARATUS AND METHOD FOR ACQUIRING AN IMAGE OF A PALLET LOAD

(75) Inventors: Dmitry Nechiporenko, Singapore (SG); Andrew Conley, Singapore (SG)

(73) Assignee: AZIMUTH INTELLECTUAL PRODUCTS PTE LTD, Singapore (SG)

(21) Appl. No.: 13/266,646

(22) PCT Filed: Apr. 30, 2009
(86) PCT No.: PCT/SG09/00157

§ 371 Date: Oct. 27, 2011

(51) Int. Cl. H04N 7/18

(52) U.S. Cl. 348/135; 348/E07.085

(57) ABSTRACT

An apparatus for acquiring an image of a pallet load comprises operating a linescan camera arranged for movement in a movement plane to acquire the image. A method of acquiring an image of a pallet load is also provided.

The invention relates to an apparatus and method for acquiring an image of a pallet load. The invention has particular, but not exclusive, application in implementing “machine vision” techniques for capturing images of a pallet of goods cartons or goods packages.

In logistics, inbound and outbound cargo control is typically an error-prone, expensive and time-consuming process requiring a substantial amount of work maintaining consistent data in WMS (Warehouse Management Systems) and ERPs (Enterprise Resource Planning Systems). The results of this cargo control processes are often hard to evaluate and contain far too little data to be of any great assistance to the warehouse management process.

Machine vision is commonly implemented in the modern logistics industry. However existing applications generally address highly-specific tasks with narrow fields of application such as:
Detecting barcodes on cartons moving through a conveyor
Reading labels of a pre-determined size from pallets
Creating images of a pallet for post-shipment audit and survey report

There are two main methods implemented to address these tasks:
1. Installing linescan cameras near a conveyor belt, scanning the barcodes (and in some cases related text/graphical information) from the cartons moving besides the camera.
2. Installing matrix cameras with a relatively large matrix (up to 16 Mpixel in existing top-level mainstream models) for capturing photographs of goods while cartons move past the camera lens.

However these approaches suffer substantial limitations.

The approaches ‘1’ and ‘2’ mostly apply to conveyor-oriented logistics facilities like sorting hubs, or to the production lines of the factories themselves. These two approaches are not applicable in some methods of cargo control. For instance, they cannot be used with palletised cargo because of technical limitations; the movement speed for approach 1 is not accurate and subject to fluctuations, thereby introducing uncertainty into the accuracy of the data captured. For approach 2, current techniques do not allow for image acquisition of sufficient resolution for the recognition of features on the cargo, such as small barcodes. When matrix cameras are proposed, the cost quickly becomes too high for this to be a practical solution.

The invention is defined in the independent claims. Some optional features of the invention are defined in the dependent claims.

The disclosed techniques create a cost effective and reliable tool which can be used to acquire images of a pallet load—e.g. one or more goods cartons or packages disposed upon a pallet. The image may or may not include the pallet itself. A “pallet” is defined as (but not limited to) a common every-day pallet used for the transportation of goods, such as one might find in a warehouse. Additionally or alternatively, a “pallet” can be considered to be a structure upon which goods can be placed and/or which is suitable for use with the techniques disclosed herein. The invention has application for use with bulk palletized cargo which represents the vast majority of the logistics traffic of ready-made goods.

This cost-effective and reliable tool is facilitated by capturing an image of the pallet load, say a complete pallet of cartons, with sufficient hi-resolution to enable barcodes with pitch less than 1 mm to be discerned clearly. The images acquired can be of at least part of, or all, of the pallet load. In addition, the disclosed techniques facilitate all types of image analysis including optical character recognition, barcode recognition and regular & irregular shape detection (e.g. damage detection). The disclosed techniques also provide a mechanism to ‘see through’ the plastic wraps which are commonly used in the palletization process.

The disclosed techniques allow for all sides of a pallet and/or the cargo thereon to be recognised for analysis. These can be implemented to minimise the amount of personal intervention/manual operation required.

The techniques disclosed herein provide for a new and inventive use of a linescan camera. These cameras are typically used in conveyor-type installations with goods passing-by besides the linescan camera on a conveyor. In such installations, there are typically variations in conveyor speed and vibration, which have a detrimental effect on captured image quality. Also conveyor systems are typically very expensive, and require approximately three to four times more floor space than plant used for the techniques disclosed herein. Furthermore, typical conveyor-type installations are simply unsuitable for palletised cargo image acquisition; they not allow for capturing all sides of a load, and are normally only capable of capturing images for a maximum of two sides of the load requiring at least two cameras. Although not limited to such a configuration, the techniques disclosed herein can be implemented to acquire images from all sides of a pallet load with the use of one linescan camera.

Therefore, the novel use of a linescan camera as claimed may be implemented because these cameras are typically relatively small and relatively light. Where the camera is precision-mounted on rails, this allows for precise movement of the camera to be effected under control of a motor, such as a servomotor or equivalent and/or linear actuators. Thus, the level of vibration in movement of the linescan camera is negligible when compared with a conveyor belt-type installation.

These techniques will now be described, by way of example only, and with reference to the accompanying drawings in which:

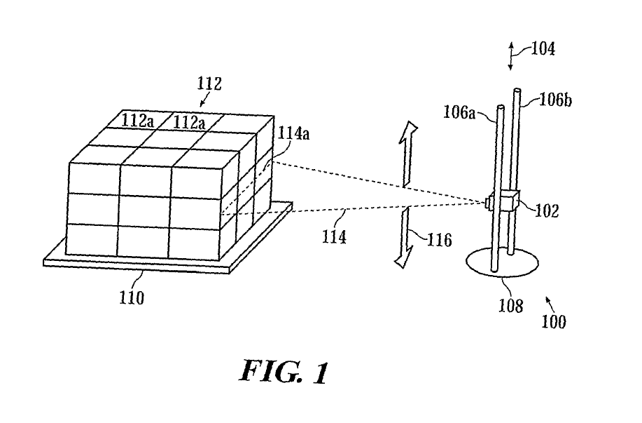

FIG. 1 is a perspective diagram illustrating a first apparatus for acquiring an image of a pallet load;

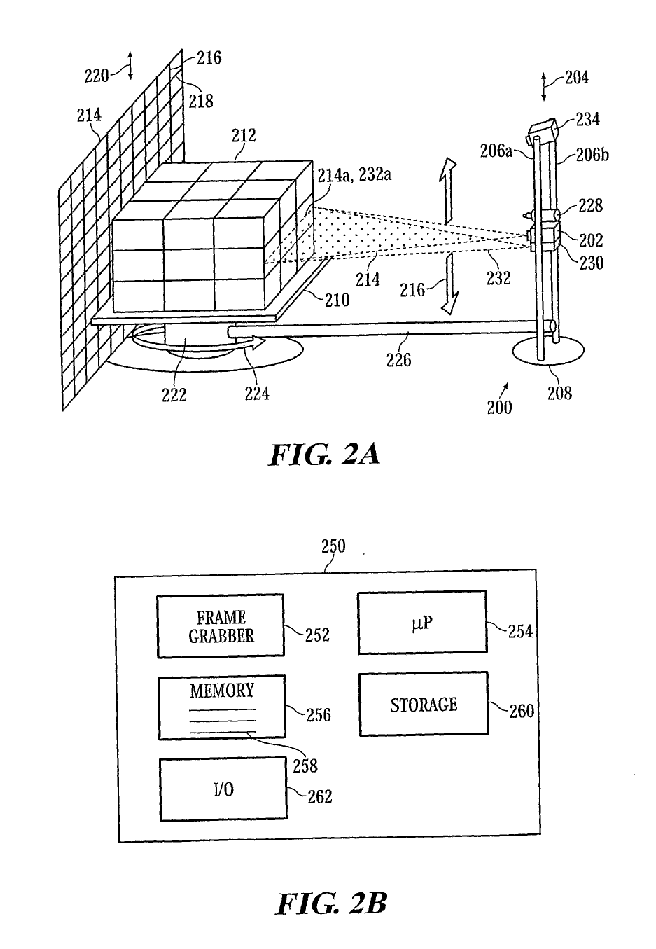

FIG. 2 is a perspective diagram illustrating a second apparatus for acquiring an image of a pallet load;

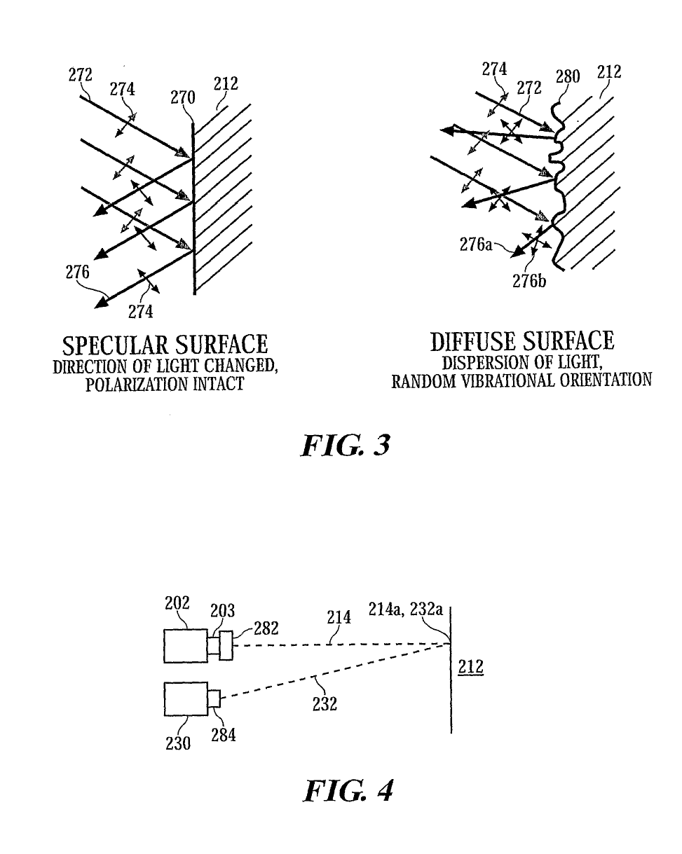

FIG. 3 is a diagram illustrating'problems which can be caused when trying to acquire an image of a pallet load using the apparatus of FIG. 1 or FIG. 2; and.

FIG. 4 is a block diagram illustrating an arrangement for alleviating the problems illustrated in FIG. 3.

Referring first to FIG. 1, a first apparatus for acquiring an image of a pallet load will now be described. The apparatus 100 comprises a line scan camera 102 arranged for movement in a movement plane 104 to acquire an image of a pallet load 112 disposed upon a pallet 110 which has been placed in position with, say, assistance from a fork lift truck (not shown). In the example of FIG. 1, pallet load 112 comprises of a plurality of goods cartons 112a stacked upon pallet 110 in an orderly manner. In this case, the goods cartons 112a are stacked in an orderly in 3×3×3 matrix. Linescan camera 102 is arranged to move vertically in plane 104. In the example, linescan camera 102 is mounted for linear movement on supports 106a, 106b which may comprise of linear actuators, having suitable drivers as will be known to the skilled person, and these are arranged upon a support base 108. Linescan camera 102 is moved, in the example of FIG. 1, from top to bottom. The field of view 114 (optical plane) of linescan camera 102 is incident on pallet load 112 at line 114a and moves in the direction 116. So, while travelling, linescan camera 102 acquires an image of the pallet load one line at a time. The result is a complete hi-resolution (for example, approximately 160 Mpixel) image. A suitable linescan camera is one which is set to grab about 6-10 lines per mm with a field of view 114 of a line being 1 pixel thick and 8000 pixel wide, but other, for example higher, resolutions are contemplated.

It will be appreciated that in FIG. 1, the linescan camera is arranged for linear movement in the vertical plane 104, but other arrangements—e.g. other directions of movement—are not excluded. For example, linescan camera could be arranged for (e.g. linear) movement in the horizontal plane as an alternative or in addition to movement in the horizontal plane.

Turning now to FIG. 2, as illustrated in FIG. 2a, a second apparatus 200 for acquiring an image of a pallet load is shown. Apparatus 200 has similar components to apparatus 100 of FIG. 1, and operates in a similar manner. Specifically, apparatus 200 comprises a line scan camera 202 arranged for movement in a movement plane 204 to acquire an image of a pallet load 212 disposed upon a pallet 210. Linescan camera 202 is arranged to move vertically in plane 204. In the example, linescan camera 202 is mounted for linear movement on supports 206a, 206b which may comprise of linear actuators, having suitable drivers as will be known to the skilled person, and these are arranged upon a support base 208. Linescan camera 202 is moved, in the example of FIG. 2, from top to bottom. The field of view 214 of linescan camera 202 is incident on pallet load 212 at line 214a and moves in the direction 216. So, while travelling, linescan camera 202 acquires an image of the pallet load one line at a time. The result is a complete hi-resolution image.

In FIG. 2, the approximate distance of the linescan camera 202 to a “front” surface of the pallet load (“front” being considered from the perspective of linescan camera 202) of about 1.5 metres, and preferably less than 2 metres. This may vary depending on the pallet load, required resolution (e.g. to read labels in sufficient detail) and exact specifications of the optical equipment used. This distance is based on the pallet load 212 comprising a stack of goods cartons of approximately 1.2 m×0.8 m×2.0 m. Effectively, the distance may be varied on a case-by-case basis to allow the linescan camera to grab sufficient information/data within its field of view.

Additionally in the example of FIG. 2, apparatus 200 comprises a calibration graphic 214 and the pallet load 212 is disposed at a position between the calibration graphic 214 and the movement plane 204. In this example, calibration graphic 214 comprises a grid of lines 216, 218 (here the lines are, respectively, vertical and horizontal lines, but other configurations such as only horizontal or only vertical lines, or lines/grids provided at angles from the horizontal/vertical are also contemplated) disposed in a plane 220 parallel to the movement plane 204 of the linescan camera 202.

Calibration graphic 214 is used in establishing dimensions of the pallet load 212.

Apparatus 200 is arranged to acquire a pre-image comprising an image of the pallet load 212 and the calibration graphic 214. This could be done with linescan camera 202, but in this example, the apparatus 200 also has a fixed camera 234 mounted on supports 206a, 206b at an elevation displaced from (e.g. above or below) the range of movement of camera 202. Camera 234 is provided for acquiring the pre-image which includes both pallet load 212 and the grid 214. As the distances between the grid lines and distance from fixed camera 234 to the calibration grid 214 are known, dimensions of the pallet load can be determined, as will be discussed in greater detail below with respect to FIG. 2b.

Use of the calibration graphic is just one tool which can be used in determining the dimensions of the pallet load. It might also be possible to detect dimensions using, say, laser projection and detection techniques, or counting space in the acquired image. In this latter example, the apparatus may make use of known templates for goods cartons, in which case, use is made of one or more known dimensions of the carton to determine a dimension of the pallet load.

The apparatus 200 of FIG. 2 also comprises a coherent light source 230 for illuminating the pallet load 212. In the example of FIG. 2, coherent light source 230 is a linelaser, arranged to generate a laser line, but other types of coherent light sources may also be used. Linelaser 230 emits a laser line having an optical plane 232 and is set up so that the optical plane 232 of the linelaser 230 is aligned with an optical plane (e.g. field of view) 214 of the linescan camera; e.g. therefore it is aligned with the CCD matrix of linescan camera 202. It is believed that the effective brightness of the linelaser backlight can, typically, be more than 10 times the brightness of the ambient light. A 50 mW linelaser can be considered to have a brightness equivalent to that of a 500 W halogen light bulb, or even better.

The respective optical planes 214, 232 are coincident at a surface of pallet load 212 at line 214a, 232a. Thus, linelaser 230 acts as a “backlight” for linescan camera 202 so that, even if the pallet load is stacked in a non-orderly fashion on the pallets, all parts of the pallet load are back-lighted properly and evenly (or at least relatively evenly, since a linelaser typically has a Gaussian light distribution) when compared to spot light sources, such as light bulbs. Therefore, performance is not deteriorated due to shadowing of lights from the warehouse.

Optionally, apparatus 200 comprises a driver for varying a distance between the linescan camera 202 and a position where the pallet is located. This is provided to ensure flexibility and to ensure the adjustment of the components of apparatus 200 can be made to maximise image quality. In one example, a mechanism is provided to bring the pallet 210 closer to the camera 234, but in the example of FIG. 2, an actuator 226 is provided to shift the camera 203 (on supports 206a, 206b, upon base 208) towards the pallet 210. To assist in automation of the procedure, the apparatus 200 may also have a rangefinder 228 to determine a distance between the camera 202 and the pallet load 212 where the apparatus 200 is arranged to operate the driver (actuator 226) responsive to a measurement of the rangefinder. Thus, if an optimal distance is known for capturing a best-quality image, the rangefinder apparatus 200 can be configured to adjust the distance between the camera 202 and the pallet load 212 to the optimal distance using the rangefinder 228 and the driver/actuator 226.

Additionally or alternatively, variations in positions of pallet load can be addressed by providing a linescan camera 202 with a suitable depth of field. For instance, the linescan camera 202 may be chosen to have a depth of field which is selected relative to a pallet dimension (e.g. height, width or depth) of the pallet load 212 or the pallet 210. So, even cartons which are far from linescan camera 202 may be in focus in the acquired image. One value for depth of field which has been found to be particularly beneficial is around 40 cm, which is approximately 50% the width of a typical euro-pallet. So even if only one row of goods cartons is present in the pallet load and is on a far side of the pallet when viewed from the perspective of linescan camera 202, the goods carton will still be captured within the image with proper quality without the need for extra operations. A camera with a depth of field of 30 cm (or thereabouts) has also been found to yield acceptable results.

As another optional extra, the apparatus 200 also comprises a rotating platform 222 for a pallet 210 to be disposed thereupon. The rotating platform 222 is arranged to rotate (e.g. in the direction 224) so that after linescan camera 202 has reached the end of travel 216 (meaning the camera has captured an entire ‘face’ of the pallet load 212) the rotating platform 222 rotates 90 degrees to enable linescan camera 202 to acquire another ‘face’ of the pallet load 212. This process can be repeated until all ‘faces’ of the pallet load are captured. If a rotating platform 222 is not to be used, multiple faces of the pallet load can be captured either by rotating the pallet manually (preferably with assistance by machinery such as a forklift truck, or similar), or by using multiple cameras positioned to capture multiple faces of the pallet. For instance, if two cameras are provided, they could be situated to capture images of opposite faces of the pallet load, or even to capture images of adjacent sides. The pallet can then be rotated, as required, for capturing image(s) of the remaining sides. Use of four cameras would allow images of all sides of the pallet to be captured without any manual rotation of the pallet.

In some cases only one or two ‘faces’ of the pallet load are required. In those cases data from the fixed camera 234 will indicate to a computing device (not shown) when the pallet 210 is rotated to the appropriate orientations and the respective ‘face’ of the pallet load 212 will be captured.

Referring now to FIG. 2b, apparatus 200 may also comprise a computing device 250 (not shown in FIG. 2a) which comprises one or more of the following components:
frame grabber 252
microprocessor 254
a memory 256, such as a RAM, for storing, at least temporarily, one or more routines 258
a storage (“hard-disk” type) memory 260
an input-output module 262 for receipt and transmission of data to/from the computing device 250.

Frame grabber 252 is used to process (e.g. gather) image data acquired from linescan camera 202, received via I/O 262 and the data is stored in storage 260 as a pure uncompressed raw bitmap image which can be processed using various image processing and data manipulation techniques, such as those described in commonly-owned International Patent Application No. PCT/SG2009/000108. When used to provide images for use with the image processing and data manipulation techniques disclosed in PCT/SG2009/000108, all information—e.g. text, barcodes, logos, labels, shipping marks, etc.—in the image for the pallet load (which may comprise a partial image of the pallet load) are used which provides a significant advantage over prior art “approach 1” and prior art “approach 2” discussed above.

As discussed above with respect to FIG. 2a, apparatus 200 may also have a fixed camera 234 for acquiring a “pre-image” of the pallet load 212 and calibration graphic 214. Alternatively, the linescan camera could be used to acquire this pre-image. The acquisition of the pre-image allows apparatus 200 to derive dimensions for the pallet load. So, computing device 250 has a processor 254 and a memory 256 for storing one or more routines 258 which, when executed under control of processor 254, causes the apparatus 200 to determine known dimensions of the pallet load 212 from the pre-image. For instance, the size of the stack of goods cartons/pallet load can be determined by apparatus 200/computing device 250 counting the number of boxes on the grid—which is defined by lines of known dimensions and/or spacing—and which are visible in the pre-image. From this, the size of the pallet load 212 can be deduced. Additionally, relative positioning of significant data elements on the goods cartons (e.g. information pieces such as labels and logos) in the pallet load 212 can be determined. This dimensional information can be used in post-processing of the acquired image data.

It is common in warehouse environments for pallet loads to be wrapped up in a polyethylene type of plastic film. This to ensure goods are unable to move around while in transit. Unfortunately this makes machine recognition of data on the pallet load, such as barcodes and text data, using optical character recognition techniques very difficult due to high occurrence of reflection caused by ambient light. This is illustrated with respect to FIG. 3.

In FIG. 3, light waves 272 are incident on a surface 272 of pallet load 212, where the surface 272 is at least relatively uniform/flat. In this example, the surface is very flat and reflective to the point of being specular. The light waves 272 are polarised with an orientation 274 of polarisation. When the light waves are reflected 276 from flat surface 270, the orientation 274 of the light waves remains unchanged.

However, if the surface of the pallet load 280 is a diffuse surface, such as one might expect with a polyethylene wrap surrounding the pallet load, the incident light waves 272 having uniform polarisation 274 are reflected in a dispersed manner so that the reflected light waves 276a have a random or semi-random “vibrational” orientation 276b. Such a phenomenon does not facilitate high-quality image recognition.

In order to obviate such problems, apparatus 200 also optionally provides a first polarising filter for the linescan camera tuned to allow light waves of a particular polarisation to be detected by linescan camera 202. Thus, the reflected light waves 276a are “filtered” so that the light waves which do not have the desired polarisation are not detected, thereby removing unwanted reflection and allowing high-quality data to be extracted from the acquired image(s).

As a further option, a second polarising filter is provided for the coherent light source/linelaser to ensure that only light waves of a preferred orientation are incident upon surface 280 of pallet load 212. Alternatively, coherent light source 230 may be arranged to emit polarised light, thus obviating the requirement for the second polarising filter.

In one implementation, the filters are linearly-polarised filters, or the coherent light source is selected as one which emits (or otherwise generates) light with a linear polarisation.

One arrangement is illustrated in the example of FIG. 4 where camera 202 is provided with a polarising filter 282 for detecting reflected light waves on optical plane 214, reflected from point 214a, 232a on pallet load 212. The reflected light is a reflection of polarised light transmitted on optical plane 232 of linelaser 230, from the linelaser and filtered by polarising filter 284. In the example, the first and second polarising filters 282, 284 are tuned relative one another to have, say, the same orientation of polarisation.

Thus, laser light that is reflected by the plastic film on the pallet load will have its polarization change but the unwanted reflections will be rejected by the polarizing filter 282 on the lens 203 of linescan camera 202. The result is linescan camera 202 can ‘see through’ the plastic film without any major high-intensity reflections corrupting the image. Up to 90-95% of reflections are typically removed using this approach. This allows for successful decoding of barcodes and accurate optical character recognition even with wrapping.

It will be appreciated that the invention has been described by way of example only. Various modifications may be made to the techniques described herein without departing from the spirit and scope of the appended claims. The disclosed techniques comprise techniques which may be provided in a stand-alone manner, or in combination with one another. Therefore, features described with respect to one technique may also be presented in combination with another technique.

1. Apparatus for acquiring an image of a pallet load, the apparatus comprising a linescan camera arranged for movement in a movement plane to acquire the image.

2. The apparatus of claim 1 comprising a calibration graphic, the apparatus being arranged for the pallet to be disposed at a position between the calibration graphic and the movement plane.

3. The apparatus of claim 2, wherein the calibration graphic comprises of lines disposed in a plane parallel to the linescan camera movement plane.

4. The apparatus of claim 2 arranged to acquire a pre-image comprising an image of the pallet load and the calibration graphic, wherein the apparatus comprises a computing device having a processor and a memory for storing one or more routines which, when executed under control of the processor cause the apparatus to determine known dimensions of the pallet load from the pre-image.

5. The apparatus of claim 1 comprising a rotating platform for a pallet to be disposed thereupon.

6. The apparatus of claim 1 comprising a driver for varying a distance between the linescan camera and a position for locating the pallet.

7. The apparatus of claim 6 comprising a rangefinder, and wherein the apparatus is arranged to operate the driver responsive to a measurement of the rangefinder.

8. The apparatus of claim 1 comprising a coherent light source for illuminating the pallet load, the apparatus being arranged for an optical plane of the coherent light source to be aligned with an optical plane of the linescan camera.

9. The apparatus of claim 1, wherein the linescan camera has a depth of field which is selected relative to a pallet dimension.

10. The apparatus of claim 1 comprising a frame grabber for processing image data captured by the linescan camera

11. The apparatus of claim 1 further comprising a computing device having a processor and a memory for storing one or more routines which, when executed under control of the processor, enables the computing device for determination of relative positions of data elements on the pallet load.

12. The apparatus of claim 1 comprising a first polarising filter for the linescan camera.

13. The apparatus of claim 12 comprising a second polarising filter for the coherent light source.

14. The apparatus of claim 13, wherein the first and second polarising filters are tuned relative one another.

15. A method of acquiring an image of a pallet load of known dimensions, the method comprising moving a linescan camera in a movement plane to acquire the image.
